(19) United States
(12) Patent Application Publication
(10) Pub. No.: US 2010/0133873 A1
(43) Pub. Date: Jun. 3, 2010

(54) MOVABLE HUNTING BLIND

(76) Inventor: Dwain CARLTON, Cameron, MO (US)

Correspondence Address: HUSCH BLACKWELL SANDERS LLP, 4801 Main Street, Suite 1000, KANSAS CITY, MO, 64112, US

(21) Appl. No.: 12/326,260

(22) Filed: Dec. 2, 2008

(51) Int. Cl. B60P 3/335; E04B 1/343; E04C 2/34

(52) U.S. Cl. 296/168; 52/169.12; 52/794.1

(57) ABSTRACT

A movable hunting blind is provided that includes a chassis with first and second axle assemblies in a tandem configuration where the first axle assembly includes steerable wheels, a coupling member extending between and pivotably connected to the first and second axle assemblies, a tongue member removably connected to and extending forwardly of the first axle assembly where the tongue member is configured for connection to a towing vehicle, a pair of transverse beams connected to proximate ends of the first and second axle assemblies, an enclosure supportably connected to the transverse beams by a plurality of brackets where each of the brackets is configured to permit some flexing movement between the transverse beams and the enclosure during transport, where the dimensions of the beams are sufficient to provide clearance between the bottom of the enclosure and the wheels of the axle assemblies, and where a wall of the enclosure includes a door configured for use in a first position as an entrance ramp and configured for use in a second position to secure the enclosure.

### CROSS-REFERENCE TO RELATED APPLICATIONS

None.

### BACKGROUND OF THE INVENTION

Game hunting has a long and storied history as being a popular pastime of sportsmen across many cultures. Today, hunting continues to be a popular activity and hunting seasons range from different seasons and climates.

Despite its popularity, there are a number of drawbacks associated with hunting including being subjected to extremely early wake up times and harsh weather conditions including rain and frigid temperatures. For certain individuals, including hunters with limited mobility, these undesirable conditions pose more than mere inconveniences.

Hunting enclosures have been popular with sportsmen and can be found in a wide variety of styles. Enclosures such as hunting blinds provide sportsmen with a measure of shelter and camouflage wild game when outdoors. The hunting enclosures that are presently available generally fall into one of two categories. Namely, semi-permanent hunting blinds and portable hunting blinds.

A permanent or semi-permanent hunting blind offers the sportsman a number of amenities, however, this type of hunting blind also suffers several drawbacks. From an economic standpoint, permanent structures tend to be more costly than portable stands in terms of materials and logistics. One the logistics front, a permanent hunting blind structure requires ownership of the land the structure is built upon or some form of permission to erect a permanent structure to begin with. Assuming that land use permission is not an issue, there is the matter of upkeep which tends to be less than convenient for a number of reasons including that hunting blinds are typically situated in a remote and distant hunting location. While the location may be ideal for hunting, the location may not offer convenient vehicle access which makes initial construction and subsequent upkeep a difficult proposition.

The group of portable hunting blinds includes the most variety of the hunting enclosure types. On one end of the portable hunting blind spectrum, some blinds that are described as “portable” may technically be moveable, but in practice, many of these require a considerable amount of effort to move into place and prepare for use. On the other end of the portable spectrum, there are lightweight units that resemble a folding chair and a weatherproof insulated parka.

Accordingly, it is desirable that a hunting blind be available that affords a measure of relief from outdoor elements yet is still portable.

### SUMMARY OF THE INVENTION

The foregoing needs are met, to a great extent, by the present invention, wherein in one aspect a movable hunting blind is provided that includes a chassis with first and second axle assemblies in a tandem configuration where the first axle assembly includes steerable wheels, a coupling member extending between and pivotably connected to the first and second axle assemblies, a tongue member removably connected to and extending forwardly of the first axle assembly where the tongue member is configured for connection to a towing vehicle, a pair of transverse beams connected to proximate ends of the first and second axle assemblies, an enclosure supportably connected to the transverse beams by a plurality of brackets where each of the brackets is configured to permit some flexing movement between the transverse beams and the enclosure during transport, where the dimensions of the beams are sufficient to provide clearance between the bottom of the enclosure and the wheels of the axle assemblies, and where a wall of the enclosure includes a door configured for use in a first position as an entrance ramp and configured for use in a second position to secure the enclosure.

Also provided is a moveable hunting blind that includes a removable skirt for covering the chassis. Additionally, an embodiment of the present inventive hunting blind where each of the beams is connected to each of the axle assemblies by one or more standoff members that supportably extend from each of the axle assemblies to the beam. Also, provided according to an embodiment of the present invention is a portable power system operable to provide power to one or more lights. Yet another feature includes at least one of the axle assemblies with a wheel lock system configured to lock the wheels of the at least one axle assembly when the tongue member is removed from the first axle assembly.

According to another embodiment of the present invention, provided is a movable hunting blind featuring a frame for supporting an enclosure in clearance above the ground for transport, the frame including, first and second axle assemblies, where at least one of the axle assemblies permits some pivotal movement during transport of the hunting blind, where the first axle assembly further includes steerable wheels, a removable tow member operatively connected to the steerable wheels of the first axle assembly, a plurality of brackets where the brackets are configured to permit some flexing movement during transport, and an enclosure connected to the frame by the plurality of the brackets, where opposite sites of the enclosure overhang opposite sides of the first and second axle assemblies, the enclosure including a door, where a first end of the door is pivotably connected to the floor of the enclosure and the door is configured for use as a ramp in a lowered position and configured for use as at least a portion of an enclosure wall in a raised position, and a pulley assembly including one or more cords where a first cord is connected to the door at a second end, where the second end is substantially opposite the first end of the door.

Additional embodiments include a portable power source operable to provide power to one or more lights, a wheel lock system configured to lock the wheels of the at least one axle assembly when the tow member is removed from the first axle assembly, and an embodiment in which the frame is connected to the enclosure by one or more standoff members that supportably extend from the frame to the enclosure.

A movable hunting blind including an enclosure having several walls, where one of the walls includes a door that is pivotably connected at a first end to the floor of the enclosure, the door being configured for use as a ramp in a lowered position and the door being further configured to secure the enclosure in a closed position, a cord connected to the door at a second end, where the second end is generally opposite to the first end of the door, a pulley assembly, where the pulley assembly is connected to an interior portion of the enclosure and the pulley assembly is operable to engage the cord for moving the door between the lowered and closed positions, a chassis including first and second axle assemblies where each of the axle assemblies includes wheels for supporting the wagon frame and enclosure in clearance relation to the ground for transport, where the wheels of the first axle assembly are steerable, a coupling member, where the first and second axle assemblies are connected to opposite ends of the coupling member and at least one of the axle assemblies is pivotably coupled to the coupling member, and a towing member that is removably and operatively connected to the steerable wheels.

According to still yet another embodiment of the present invention, a moveable hunting blind is provided where first and second axle assemblies are pivotably coupled to the coupling member. Also included is a moveable hunting blind with insulated floors and walls.

Certain embodiments of the invention are outlined above in order that the detailed description thereof may be better understood, and in order that the present contributions to the art may be better appreciated. In this respect, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention. Though some features of the invention may be claimed in dependency, each feature has merit when used independently.

### BRIEF DESCRIPTION OF THE SEVERAL VIEWS OF THE DRAWING

In the accompanying drawings, which form a part of the specification and are to be read in conjunction therewith in which like reference numerals are used to indicate like or similar parts in the various views. Further features of the present invention will become apparent to those skilled in the art to which the present invention relates from reading the following description with reference to the accompanying drawings, in which:

FIG. 1 is an exploded profile view of a moveable hunting blind according to an embodiment of the present invention;

FIG. 2 is a perspective view of a chassis in accordance with an embodiment of the present invention;

FIG. 3 is front partial view of a frame in accordance with an embodiment of the present invention;

FIG. 4 is a partial front showing a portion of the frame and chassis in accordance with an embodiment of the present invention;

FIG. 5 is a rear quarter view of a moveable hunting blind in accordance with an embodiment of the present invention;

FIG. 6 is a perspective view showing a portion of the lower corner of the moveable hunting blind in accordance with an embodiment of the present invention.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the Figures. Instead, the sizes of certain small components may have been exaggerated for illustration.

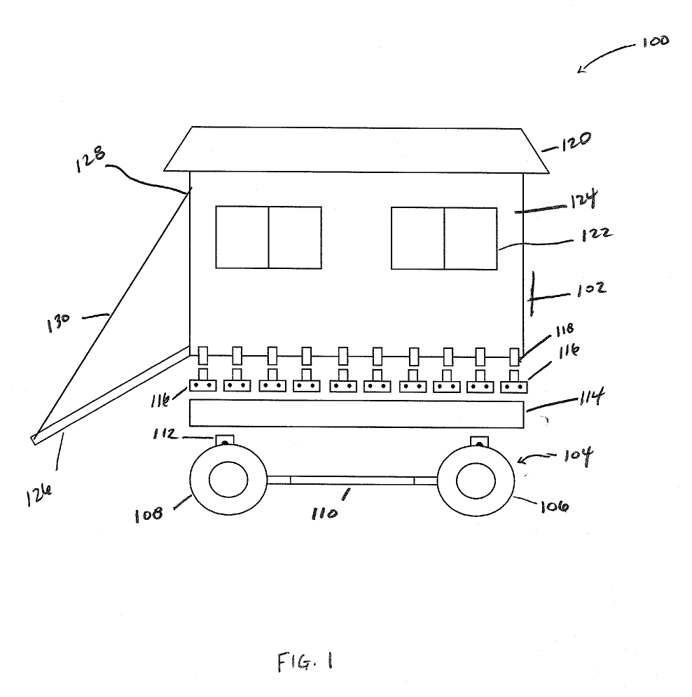

Turning to FIG. 1, shown is an exploded profile view of a moveable hunting blind 100 according to an embodiment of the present invention. As shown, the hunting blind includes an enclosure 102 that is supported by a chassis 104. The chassis includes front and rear axle assemblies 106, 108 that are connected via a coupling pole 110. Each of the axle assemblies 106, 108 includes a pair of standoffs 112 that are attached to a pair of beams 114. According to some embodiments, the beams 114 are configured in a substantially transverse orientation. Each beam 114 is attached to several brackets 116. Each bracket 116 is attached to the enclosure 102 by one or more enclosure supports 118.

The enclosure 102 features a roof 120, windows 122, and walls 124. Additionally, the enclosure 102 includes a door 126 that is attached to a lower portion of the enclosure 102 and is configured to be lowered from an upper portion so that the door 126 is a ramp in an open, lowered configuration and is a wall when in a raised, closed position. The enclosure 102 includes a pulley assembly 128 that is attached to the door by a rope or cord 130. The pulley assembly 128 is configured to raise the door 126 into a closed position and lower the door into an open, ramp position.

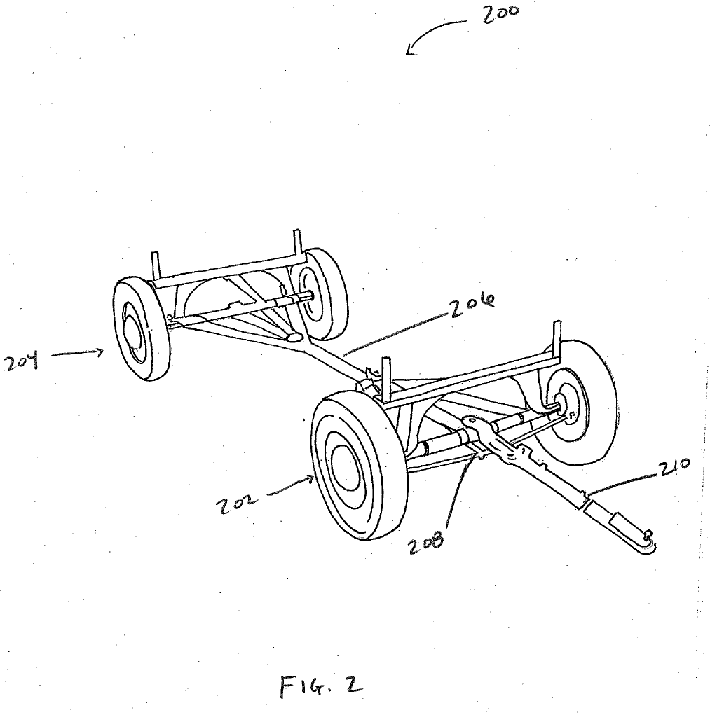

FIG. 2 is a perspective view of a chassis 200 according to an embodiment of the present invention. The chassis 200 includes front 202 and rear 204 axle assemblies that are pivotably connected by a coupling member 206. The coupling member 206 may be configured to pivot at a single or in multiple positions. The front axle 202 includes steerable linkage 208 that is operatively connected to a removable tongue member 210. According to some embodiments of the present invention, one or more of the axle assemblies 202, 204 are configured to lock upon removal of the tongue member 210. Locking of an axle assembly together with removal of the tongue member makes unauthorized movement of the portable hunting blind difficult. An example of chassis can be found on the steerable farm wagon shown in U.S. Pat. No. 3,556,561 for Farm Wagon Running Gear, the disclosure of which is incorporated herein by reference.

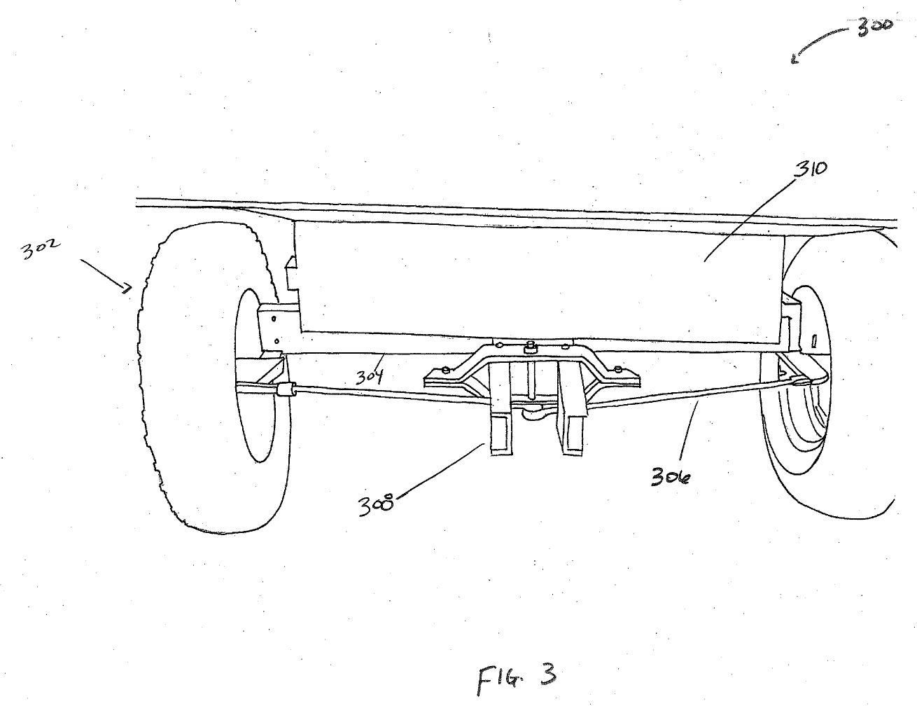

FIG. 3 is front partial view of a frame 300 in accordance with an embodiment of the present invention. The front axle assembly 302 includes an axle 304, steerable linkage 306, and a tongue member mount 308. Also shown is an enclosure support 310 which runs in a substantially parallel configuration to the axle assembly 302.

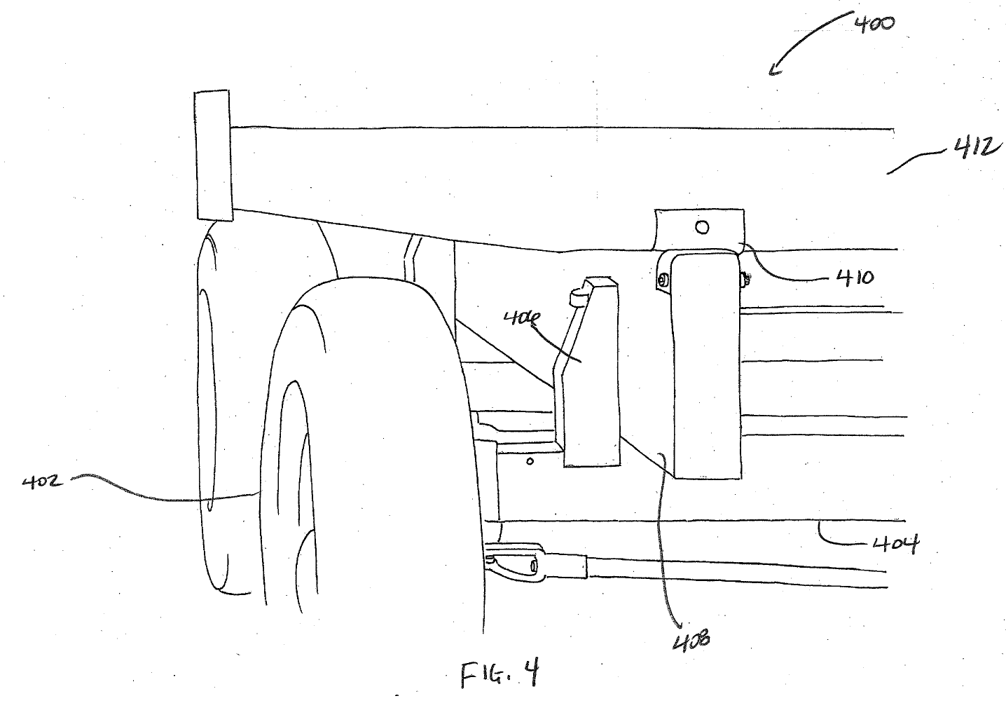

FIG. 4 is a perspective view of an upper portion of a frame 400 in accordance with an embodiment of the present invention. The front axle assembly 402 includes an axle 404 and a pair of standoffs 406. A beam 408 is mounted to the axle assemblies 402 via standoffs 406. A beam 408 is connected to a first portion of a bracket 410. An enclosure support 412 which runs in a substantially parallel configuration to the axle assembly 402 is connected to a second portion of the bracket 410. As shown, the first portion of the bracket 410 is substantially perpendicular to a second portion of the bracket. The first portion of the bracket 410 is attached to the beam 408 via any number of conventional methods, including lag bolts, bolts, nails, screws, and the like. The second, substantially perpendicular portion of the bracket 410 is attached to the enclosure support 412 in a manner that permits some pivotal movement of the enclosure support relative to the beam.

As shown, the second portion of each bracket 410 is attached to the enclosure support 412 at a single point, thereby permitting some pivotal movement of the enclosure support 412 during transport. Allowing some pivotal movement of the enclosure support 412 relative to the beams 408 permits the moveable hunting blind to track well, even with transported over rough and uneven terrain. Additionally, the pivotal movement permitted by the bracket 410 subjects the enclosure to less torsional stress during transport because there is some give.

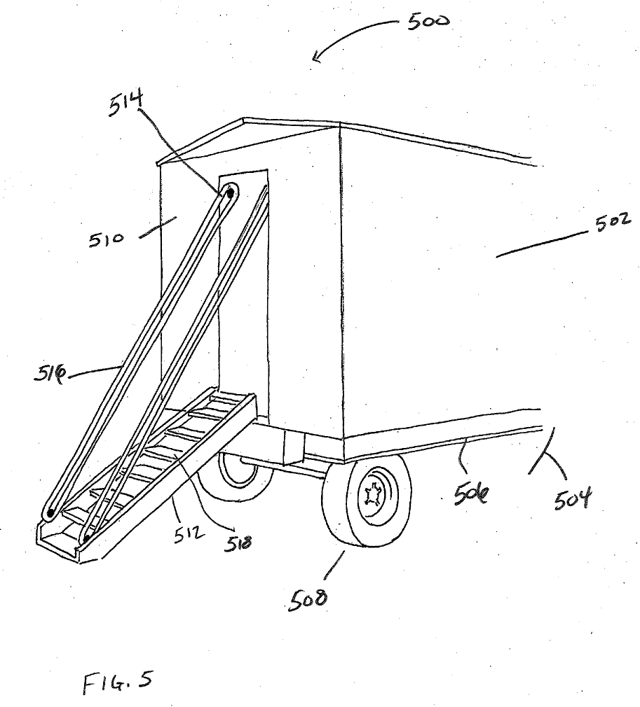

FIG. 5 is a rear quarter view of a moveable hunting blind 500 in accordance with an embodiment of the present invention. The hunting blind 500 includes an enclosure 502 that is supported by a frame 504. As shown, beams 506 and a portion of the rear axle assembly 508 of the frame 504 is visible. A rear wall 510 of the enclosure 502 includes a door 512 to enter the enclosure 502. A lower portion of the door 512 is pivotably attached to a lower portion of rear wall 510 of the enclosure 502. The rear wall 510 of the enclosure 502 further includes a pulley assembly 514 that is attached to an upper portion of the door 512 by a rope or cord 516. The pulley assembly 514 is attached to a portion of the rear wall 510 of the enclosure 502 at a position that is above the point at which the lower portion of the door 512 is pivotably mounted to the lower portion of the enclosure 502. As previously described, the door 512 is configured to be lowered from an upper portion so that the door is a ramp in an open, lowered configuration and is a wall when in a raised, closed position. As shown, the interior portion of the door 512 (when closed) includes stairs 518 to facilitate entry into the enclosure 502 when the door 512 is in a lowered, open position. Additionally, when lowered, a support is provided by the portion of the rope 516 running from the pulley assembly 514 to the point at which the rope is attached to the door 512. The rope 516 may be used to assist an individual in entering or exiting the enclosure 502.

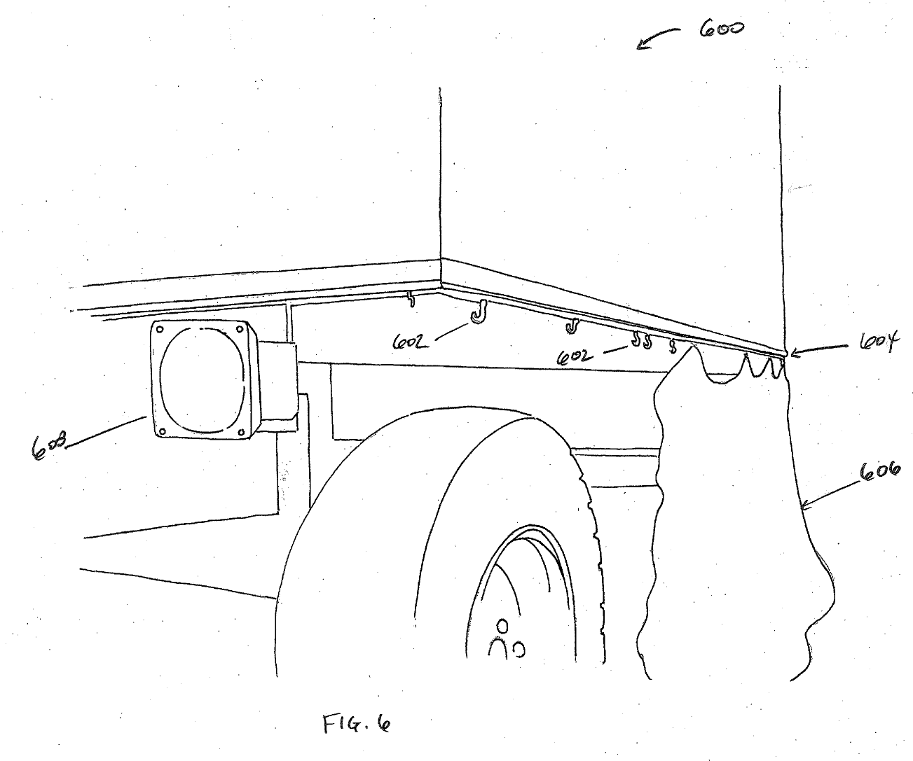

FIG. 6 is a perspective view showing a portion of the lower corner of the moveable hunting blind 600 in accordance with an embodiment of the present invention. Hooks 602 are set along the lower perimeter of the enclosure 604 for attachment of a skirt 606 or other covering. The skirt 606 covers the lower portion of the moveable hunting blind 600. Also shown are trailer lights 608 for use during transport of the moveable hunting blind 600. The trailer lights 608 may be powered by any conventional means for powering lights such as the trailer wiring of a tow vehicle or a power system inside the enclosure. It will further be appreciated by one of skill in the art that the moveable hunting blind may include batteries that are charged via solar or wind energy.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A movable hunting blind comprising:
a chassis with first and second axle assemblies in a tandem configuration wherein said first axle assembly includes steerable wheels;
a coupling member extending between and pivotably connected to said first and second axle assemblies;
a tongue member removably connected to and extending forwardly of said first axle assembly wherein said tongue member is configured for connection to a towing vehicle;
a pair of transverse beams connected to proximate ends of said first and second axle assemblies;
an enclosure supportably connected to said transverse beams by a plurality of brackets wherein each of said brackets is configured to permit some flexing movement between said transverse beams and said enclosure during transport, wherein the dimensions of said beams are sufficient to provide clearance between the bottom of said enclosure and the wheels of said axle assemblies; and
wherein a wall of said enclosure includes a door configured for use in a first position as an entrance ramp and configured for use in a second position to secure said enclosure.

2. The movable hunting blind of claim 1 wherein opposite sides of said enclosure overhang opposite sides of said axle assemblies.

3. The moveable hunting blind of claim 2 further comprising a skirt operable to be removably attached to the lower perimeter of said enclosure for covering said chassis.

4. The movable hunting blind of claim 1 wherein each of said beams is connected to each of said axle assemblies by one or more standoff members that supportably extend from each of said axle assemblies to said beam.

5. The moveable hunting blind of claim 1 further comprising a portable power system operable to provide power to one or more lights.

6. The moveable hunting blind of claim 1 wherein at least one of said axle assemblies further comprises a wheel lock system configured to lock the wheels of said at least one axle assembly when said tongue member is removed from said first axle assembly.

7. A movable hunting blind comprising:
a frame for supporting an enclosure in clearance above the ground for transport, said frame comprising:
first and second axle assemblies, wherein at least one of said axle assemblies permits some pivotal movement during transport of the hunting blind, wherein said first axle assembly further comprises steerable wheels;
a removable tow member operatively connected to said steerable wheels of said first axle assembly;
a plurality of brackets wherein said brackets are configured to permit some flexing movement during transport; and
an enclosure connected to said frame by said plurality of said brackets, wherein opposite sites of said enclosure overhang opposite sides of said first and second axle assemblies, said enclosure comprising a door, wherein a first end of said door is pivotably connected to the floor of said enclosure and said door is configured for use as a ramp in a lowered position and configured for use as at least a portion of an enclosure wall in a raised position; and
a pulley assembly comprising one or more cords where a first cord is connected to said door at a second end, wherein said second end is substantially opposite said first end of said door.

8. The movable hunting blind of claim 7 further comprising a portable power source operable to provide power to one or more lights.

9. The moveable hunting blind of claim 7 wherein at least one of said axle assemblies further comprises a wheel lock system configured to lock the wheels of said at least one axle assembly when said tow member is removed from said first axle assembly.

10. The movable hunting blind of claim 7 wherein said frame is connected to said enclosure by one or more standoff members that supportably extend from said frame to said enclosure.

11. The moveable hunting blind of claim 7 further comprising a skirt operable to be removably attached to the lower perimeter of said enclosure for covering said frame.

12. A movable hunting blind comprising:
an enclosure having a plurality of walls, wherein one of said walls includes a door that is pivotably connected at a first end to the floor of said enclosure, said door being configured for use as a ramp in a lowered position and said door being further configured to secure said enclosure in a closed position;
a cord connected to said door at a second end, wherein said second end is generally opposite to said first end of said door;
a pulley assembly, wherein said pulley assembly is connected to an interior portion of said enclosure and said pulley assembly is operable to engage said cord for moving said door between said lowered and closed positions;
a chassis including first and second axle assemblies wherein each of said axle assemblies comprises wheels for supporting said wagon frame and enclosure in clearance relation to the ground for transport, wherein said wheels of said first axle assembly are steerable;
a coupling member, wherein said first and second axle assemblies are connected to opposite ends of said coupling member and at least one of said axle assemblies is pivotably coupled to said coupling member; and
a towing member that is removably and operatively connected to said steerable wheels.

14. The moveable hunting blind of claim 13 wherein said first and second axle assemblies are pivotably coupled to said coupling member.

15. The movable hunting blind of claim 12 further comprising a portable power system operable to provide power to one or more lights.

16. The moveable hunting blind of claim 12 wherein at least one of said axle assemblies further comprises a wheel lock system configured to lock the wheels of said at least one axle assembly when said towing member is removed from said first axle assembly.

17. The movable hunting blind of claim 12 wherein said chassis is connected to said enclosure by one or more standoff members that supportably extend from said chassis to said enclosure

18. The moveable hunting blind of claim 12 further comprising a skirt operable to be removably attached to the lower perimeter of said enclosure for covering said chassis.

19. The moveable hunting blind of claim 12 wherein said enclosure further comprises insulated floors.

20. The moveable hunting blind of claim 12 wherein said enclosure further comprises insulated walls.
